(19) United States
(12) Patent Application Publication
(10) Pub. No.: US 2011/0227352 A1
(43) Pub. Date: Sep. 22, 2011

(54) Door shipping clip

(76) Inventor: Jason Landry, St. Peters (CA)

(21) Appl. No.: 12/661,517

(22) Filed: Mar. 18, 2010

(51) Int. Cl. E05C 19/18

(52) U.S. Cl. 292/297

(57) ABSTRACT

A door shipping clip for securing a pre-hung door to a door jamb in a closed position during shipping is provided. The door shipping clip comprises a substantially rigid door interacting portion for interacting with a surface of the door in proximity of a door lock bore disposed in the door and an elongated bendable strike jamb interacting portion extending from the door interacting portion for being disposed through the door lock bore and for interacting with a surface of the strike jamb. The strike jamb interacting portion in concert with the door interacting portion for holds the door in a closed position with a strike edge of the door abutting a respective abutting surface of the strike jamb.

### FIELD OF THE INVENTION

The present invention relates to the field of pre-hung door assemblies, and more particularly to a door shipping clip for securing a pre-hung door to a door jamb in a closed position during shipping.

### BACKGROUND OF THE INVENTION

In present day construction it is common practice to manufacture doors as pre-hung door assemblies to simplify the installation and to reduce the cost. Pre-hung door assemblies include a frame structure in which a door is pre-hung (hinged). The door is properly spaced relative to opposing frame portions. The door and the door jambs are prepared for the installation of door hardware—such as lock sets, knobs, latches, etc.—but are not fitted therewith. The pre-hung door is attached to the hinge jamb by hinges and requires a fastener to hold the door in a closed position relative to the door jambs during shipment. If the door is not secured to the door jambs in a closed position, the door and the door jamb are readily damaged.

Manufacturers use various techniques to secure the door to the door jambs. For example, nails are driven through the strike jamb into the edge of the door. However, removing the nails prior installation is a laborious task and leave holes in the edge of the door and the face of the strike jamb. Another example is the use of nylon straps placed around the door and the door jambs or through the lock bore of the door and around the strike jamb. The nylon straps frequently rub against sharp edges during shipping and break. Further examples include fastening devices that are disposed in the lock bolt bore of the door and the respective lock bolt bore of the strike jamb as well as wooden blocks and felt pads that are attached through the lock bore. Unfortunately, the mounting and removal of such fastening devices are complex and time consuming tasks.

It is desirable to provide a door shipping clip for securing a pre-hung door to a door jamb in a closed position during shipping that is easy to mount and remove.

It is also desirable to provide a door shipping clip for securing a pre-hung door to a door jamb in a closed position during shipping that reliably secures the door to the door jamb during shipping.

It is also desirable to provide a door shipping clip for securing a pre-hung door to a door jamb in a closed position during shipping that is simple and cost effective to manufacture.

### SUMMARY OF THE INVENTION

Accordingly, one object of the present invention is to provide a door shipping clip for securing a pre-hung door to a door jamb in a closed position during shipping that is easy to install and remove.

Another object of the present invention is to provide a door shipping clip for securing a pre-hung door to a door jamb in a closed position during shipping that reliably secures the door to the door jamb during shipping.

Another object of the present invention is to provide a door shipping clip for securing a pre-hung door to a door jamb in a closed position during shipping that is simple and cost effective to manufacture.

According to one aspect of the present invention, there is provided a door shipping clip for securing a pre-hung door to a door jamb in a closed position during shipping. The door shipping clip comprises a substantially rigid door interacting portion for interacting with a surface of the door in proximity of a door lock bore disposed in the door and an elongated bendable strike jamb interacting portion extending from the door interacting portion for being disposed through the door lock bore and for interacting with a surface of the strike jamb. The strike jamb interacting portion in concert with the door interacting portion for holds the door in a closed position with a strike edge of the door abutting a respective abutting surface of the strike jamb.

According to another aspect of the present invention, there is further provided a door shipping clip for securing a pre-hung door to a door jamb in a closed position during shipping. The door shipping clip comprises a substantially rigid door interacting portion for interacting with a surface of the door in proximity of a door lock bore disposed in the door and an elongated bendable strike jamb interacting portion extending from the door interacting portion for being disposed through the door lock bore and for interacting with a surface of the strike jamb. The strike jamb interacting portion in concert with the door interacting portion for holds the door in a closed position with a strike edge of the door abutting a respective abutting surface of the strike jamb. The door shipping clip further comprises a guiding portion interposed between the door interacting portion and the strike jamb interacting portion for interacting with a surface of the door lock bore to position the door shipping clip with respect to the door lock bore.

The advantage of the present invention is that it provides a door shipping clip for securing a pre-hung door to a door jamb in a closed position during shipping that is easy to install and remove.

A further advantage of the present invention is that it provides a door shipping clip for securing a pre-hung door to a door jamb in a closed position during shipping that reliably secures the door to the door jamb during shipping.

A further advantage of the present invention is that it provides a door shipping clip for securing a pre-hung door to a door jamb in a closed position during shipping that is simple and cost effective to manufacture.

### BRIEF DESCRIPTION OF THE DRAWINGS

A preferred embodiment of the present invention is described below with reference to the accompanying drawings, in which:

FIG. 1a is a simplified block diagram illustrating a cross-sectional view of a pre-hung door assembly;

FIGS. 1b and 1c are simplified block diagrams illustrating in a detail of the cross-sectional view illustrated in FIG. 1a a door shipping clip according to a preferred embodiment of the invention during and after a mounting process, respectively;

FIGS. 2a and 2b are simplified diagrams illustrating a perspective view of a preferred implementation of the door shipping clip according to a preferred embodiment of the invention;

FIGS. 3a to 3c are simplified diagrams illustrating a perspective view of a pre-hung door assembly with the preferred implementation of the door shipping clip according to a preferred embodiment of the invention;

FIG. 4 is a simplified block diagram illustrating a side view of a door shipping clip according to another embodiment of the invention;

FIG. 5a is a simplified block diagram illustrating a side view of a door shipping clip according to yet another embodiment of the invention;

FIG. 5b is a simplified block diagram illustrating in a detail of the cross-sectional view illustrated in FIG. 1a removal of the door shipping clip illustrated in FIG. 5a;

FIG. 6a is a simplified block diagram illustrating a top view of a door shipping clip according to yet another embodiment of the invention before folding; and,

FIGS. 6b and 6c are simplified block diagrams illustrating a top view and a side view of the door shipping clip illustrated in FIG. 6a after folding, respectively;

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

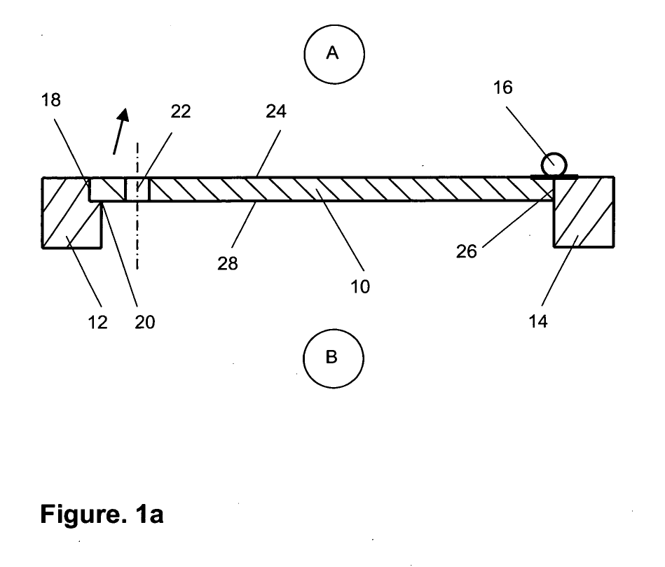

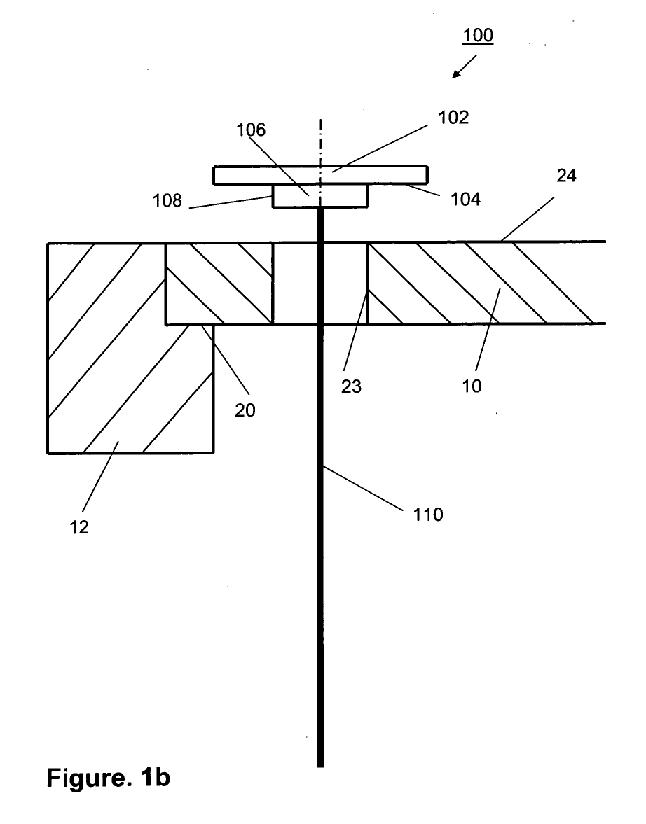

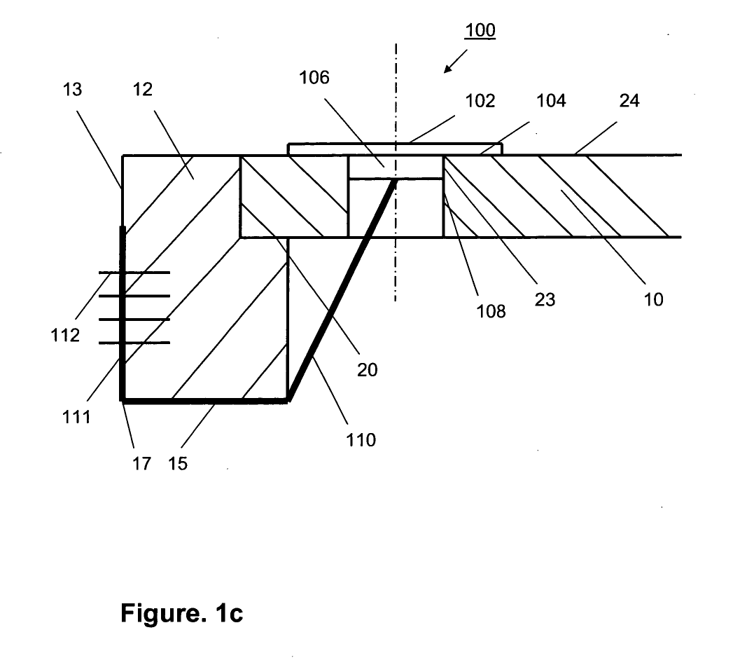

Referring to FIGS. 1a to 1c, 2a and 2b, and 3a to 3c, a door shipping clip 100 for securing a pre-hung hinged door to a door jamb in a closed position during shipping according to a preferred embodiment of the invention is provided. FIG. 1a illustrates a cross-sectional view of a pre-hung door assembly. A hinge edge 26 of door 10 is mounted to hinge jamb 14 via hinges 16. The door 10 opens around a pivot provided by the hinges 16 towards Inside (A) as indicated by the arrow. For shipping purposes, the door 10 is held in a closed position with surface 24 facing Inside (A) and surface 28 facing Outside (B), as illustrated in FIG. 1a. In the closed position strike edge 18 of the door 10 is abutted by respective abutting surface 20 of strike jamb 12. Door lock bore 22 is, for example, provided according to standard shape and size for accommodating respective door hardware therein but is not fitted therewith.

The door shipping clip 100 according to the preferred embodiment of the invention comprises a substantially rigid door interacting portion 102 having interacting surface 104 for interacting with the surface 24 of the door 10 in proximity of the door lock bore 22. Elongated bendable strike jamb interacting portion 110 extends, preferably substantially perpendicular to the interacting surface 104, from the door interacting portion 102. During a mounting process the strike jamb interacting portion 110 is disposed through the lock bore 22, as illustrated in FIG. 1b, until the interacting surface 104 is in contact with the surface 24 of the door 10. While providing sufficient pulling action to keep the door 10 in the closed position the strike jamb interacting portion 110 is preferably brought in contact with outside facing surface 15 of the strike jamb 12 and bent around edge 17 between the outside facing surface 15 and wall facing surface 13 of the strike jamb 12. Finally, a mounting section 111 of the strike jamb interacting portion 110 is temporarily secured to the wall facing surface 13 of the strike jamb 12 using, for example, nails 112 or staples, as illustrated in FIG. 1c. The strike jamb interacting portion 110 in concert with the door interacting portion 102 then holds the door in the closed position.

Optionally, a protective layer of a soft material such as, for example, felt is interposed between the interacting surface 104 of the door shipping clip 100 and the surface 24 of the door 10 in order to protect the surface 24 from damage such as abrasions.

Preferably, a guiding portion 106 is interposed between the door interacting portion 102 and the strike jamb interacting portion 110. The guiding portion 106 is designed such that it is accommodated in the door lock bore 22 having, for example, a substantially snug fit between surface 108 of the guiding portion 106 and surface 23 of the door lock bore 22. Provision of the guiding portion 106 facilitates mounting of the door clip 100 by holding the door shipping clip 100 in a fixed predetermined position when inserted into the door lock bore 22.

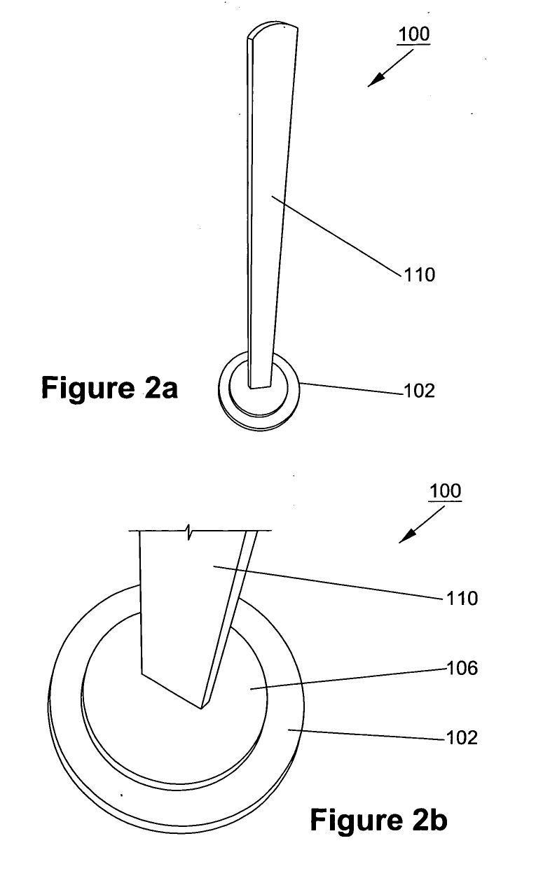

Further preferably, the door shipping clip 100 is manufactured as a single unit, as illustrated in FIGS. 2a and 2b, using standard plastic molding techniques and standard plastic composite materials. Depending on the plastic material used and the size of the door lock bore 22, the door interacting portion 102, the guiding portion 106 and the strike jamb interacting portion 110 are designed such that door interacting portion 102 is substantially rigid while the strike jamb interacting portion 110 is sufficiently flexible to enable bending. The door shipping clip 100 illustrated in FIGS. 2a and 2b is produced in a simple and cost effective fashion.

Optionally, the door shipping clip 100 is manufactured using other materials such as, for example, various types of metals or metal alloys. Further optionally, the door shipping clip 100 comprises a plurality of components made of different materials mounted together. For example, the door interacting portion 102 and the guiding portion 106 are manufactured as one piece made of wood having the strike jamb interacting portion 110 made of a flexible plastic material mounted thereto using standard mounting devices such as, for example, screws or nails.

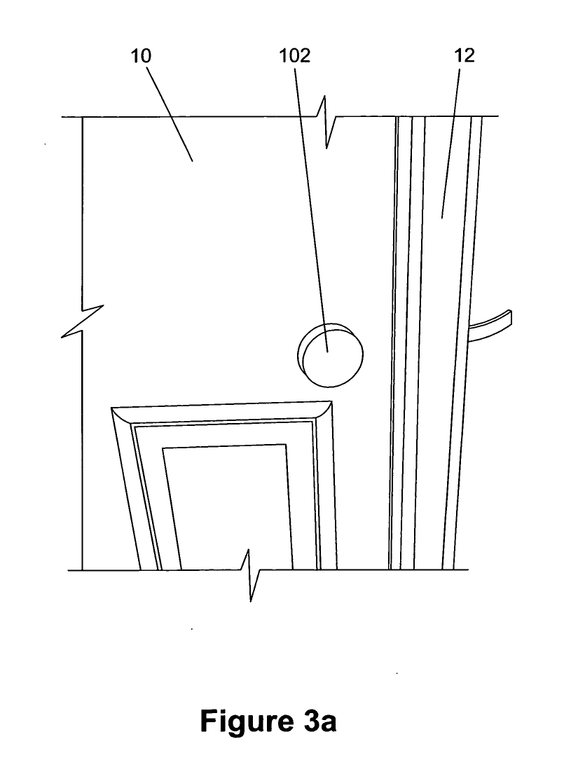

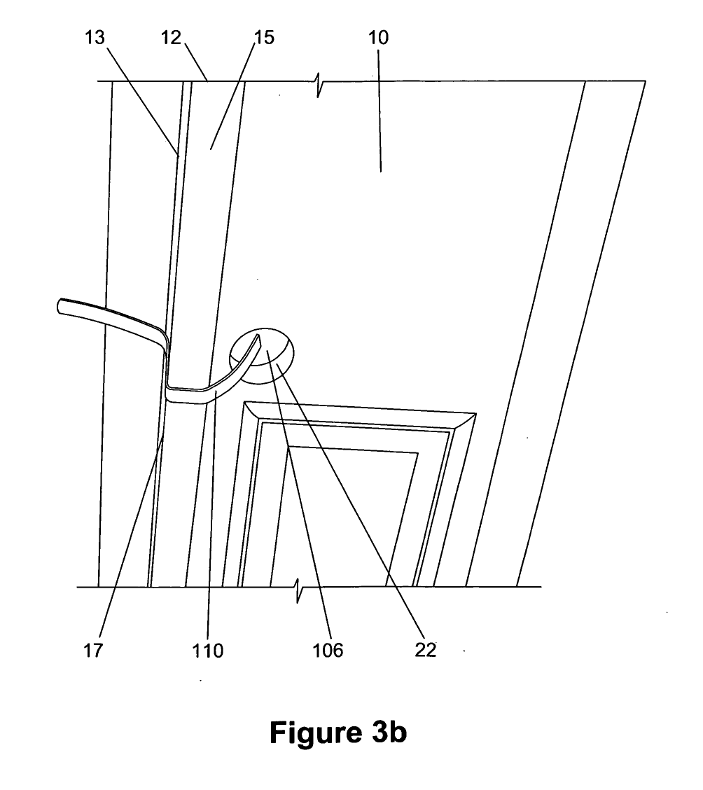

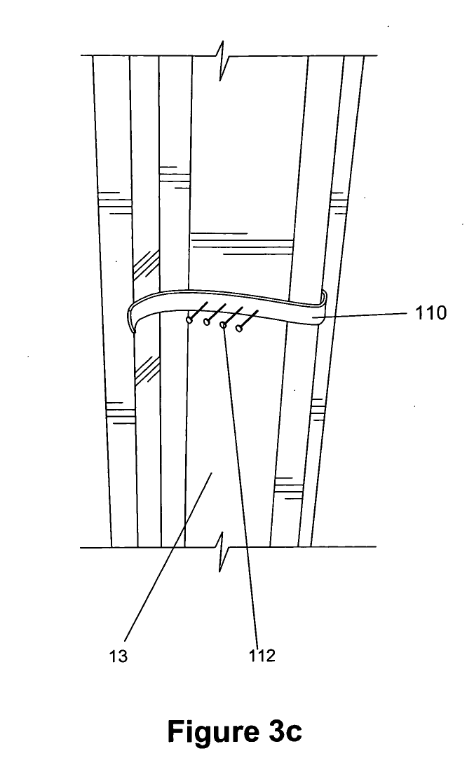

FIGS. 3a to 3c illustrate perspective views of a pre-hung door assembly with the door shipping clip 100 for holding the door 10 in a closed position. As illustrated in FIG. 3a, the door interacting portion 102 is designed as a round cap having a flat outside surface. For example, the outside surface of the door interacting portion 102 is customizable with a corporate logo of the door manufacturer on a sticker attached thereto for providing retail appeal. Optionally, the cap has other shapes than a round flat outside surface, for example, the shape of a half sphere or a ball imitating a door knob. Further optionally, the door interacting portion 102 has a shape other than a cap such as, for example, a beam structure of sufficient length for spanning across the door lock bore and having sufficient surface area for interacting with the door surface 24 without damaging the same. As illustrated in FIGS. 3b and 3c, the guiding portion 106 of the door shipping clip 100 is easily inserted into the door lock bore 22 and the strike jamb interacting portion 110 is easily bent around the edge 17 between the outside facing surface 15 and the wall facing surface 13 of the strike jamb 12 and mounted to the wall facing surface 13 of the strike jamb 12 using nails 112. As illustrated, the door shipping clip 100 is simple and fast to install and holds the door substantially firmly in the closed position and does not damage the door 10 or visible portions of the strike jamb 12. Optionally, the door shipping clip 100 enables use in an automated process using, for example: a feeding tool for inserting the door shipping clip 100 into the door lock bore 22; a gripping tool for gripping, bending, and holding the strike jamb interacting portion 110; and a mounting tool for mounting the strike jamb interacting portion 110 to the wall facing surface 13 of the strike jamb 12.

Furthermore, the door shipping clip 100 is simple to remove. For example, the nails 112 are removed and the strike jamb interacting portion 110 is pulled through the door lock bore prior installation of the door assembly. Alternatively, the door assembly is installed with the door shipping clip 100. The strike jamb interacting portion 110 is then cut in proximity of the edge 17 between the outside facing surface 15 and the wall facing surface 13 of the strike jamb 12 allowing pulling a first part of the strike jamb interacting portion 110 through the door lock bore 22 for removing the door shipping clip. The remaining second part of the strike jamb interacting portion 110 mounted to the wall facing surface 13 of the strike jamb 12 is then hidden after installation of a cover plate for covering the gap between the door frame and the wall.

Use of the door shipping clip 100 made of plastic material with standard door assemblies securely holds the door 10 in the closed position without damaging the surface 24 of the door 10 absent a protective layer of a soft material interposed between the interacting surface 104 of the door shipping clip 100 and the surface 24 of the door 10.

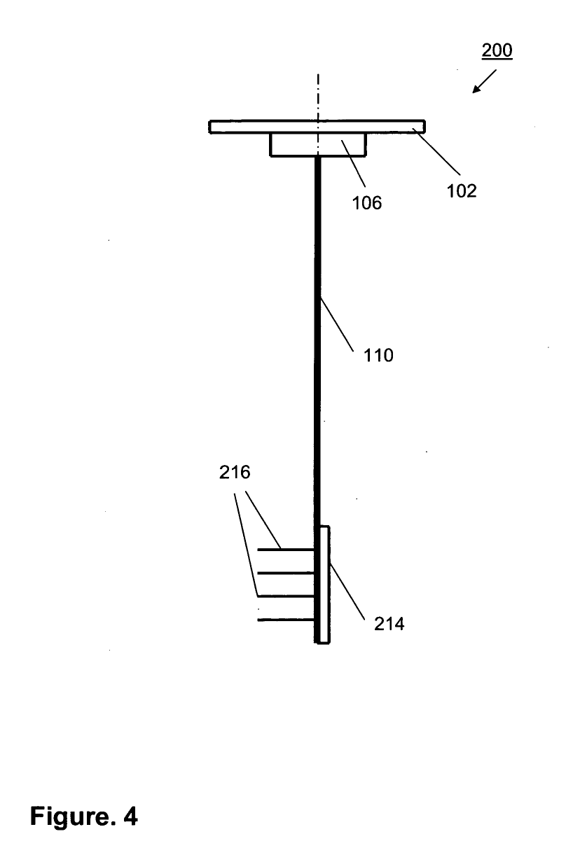

Referring to FIG. 4, a door shipping clip 200 according to another embodiment of the invention is provided. The strike jamb interacting portion 110 of the door shipping clip 200 comprises a mounting structure 214 for being mounted via nails 216 thereof to the wall facing surface 13 of the strike jamb 12. The mounting structure 214 comprises, for example, a commercially available nail plate which is, for example, embedded into the strike jamb interacting portion 110 using a plastic molding process. Alternatively, the mounting structure 214 is mounted to the strike jamb interacting portion 110 by driving the nails 216 there through.

Further alternatively, mounting of the strike jamb interacting portion 110 to the wall facing surface 13 of the strike jamb 12 is obviated by manufacturing the strike jamb interacting portion 110 using a material that enables plastic deformation during the process of bending around the edge 17 between the outside facing surface 15 and the wall facing surface 13 of the strike jamb 12, i.e. the strike jamb interacting portion 110 keeps its U-shape after bending. Suitable materials that are plastically deformable and provide sufficient strength for holding the door 10 in the closed position are, for example, metals such as steel or aluminum as well as some types of plastic materials.

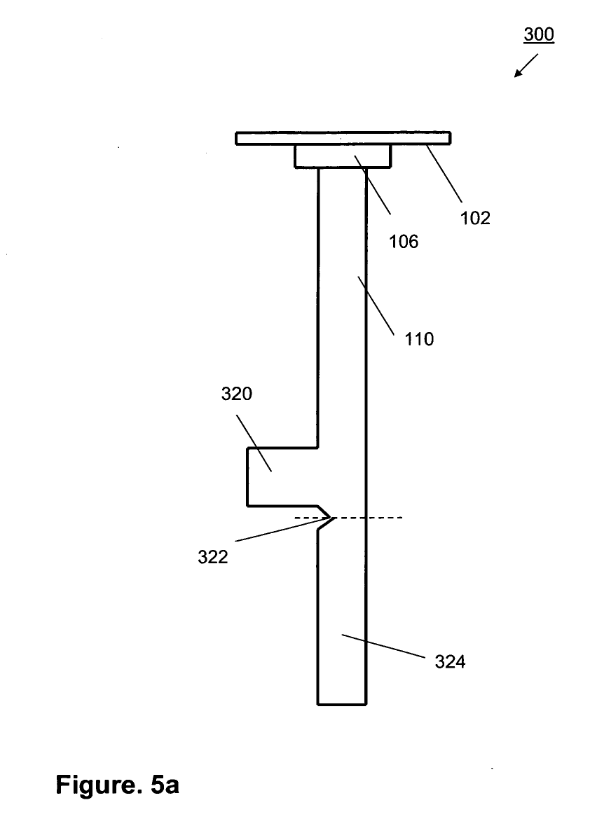

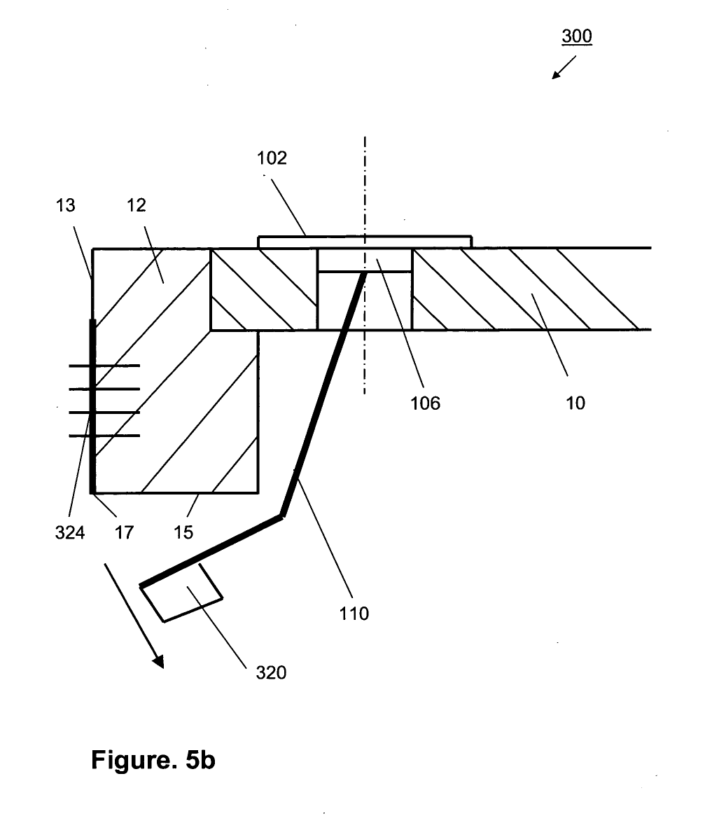

Referring to FIGS. 5a and 5b, a door shipping clip 300 according to another embodiment of the invention is provided. Here, the strike jamb interacting portion 110 comprises a removal mechanism 320, 322 for facilitating removal of the door shipping clip after installation. The removal mechanism comprises a weakened area 322 of removed material such as, for example, a V-shaped cut and a gripping area 320. For example, for removing the door shipping clip 300 the strike jamb interacting portion 110 is torn at the weakened zone 322 approximately along the dashed line, as illustrated in FIGS. 5a and 5b, by pulling the gripping area 320—as indicated by the arrow in FIG. 5b—using, for example, pliers. The door shipping clip 300 is then removed while the mounting portion 324 is left mounted to the wall facing surface 13 of the strike jamb 12. The weakened area is placed along the strike jamb interacting portion 110 such that it coincides with the edge 17 between the outside facing surface 15 and the wall facing surface 13 of the strike jamb 12. Optionally, the gripping area 320 is omitted.

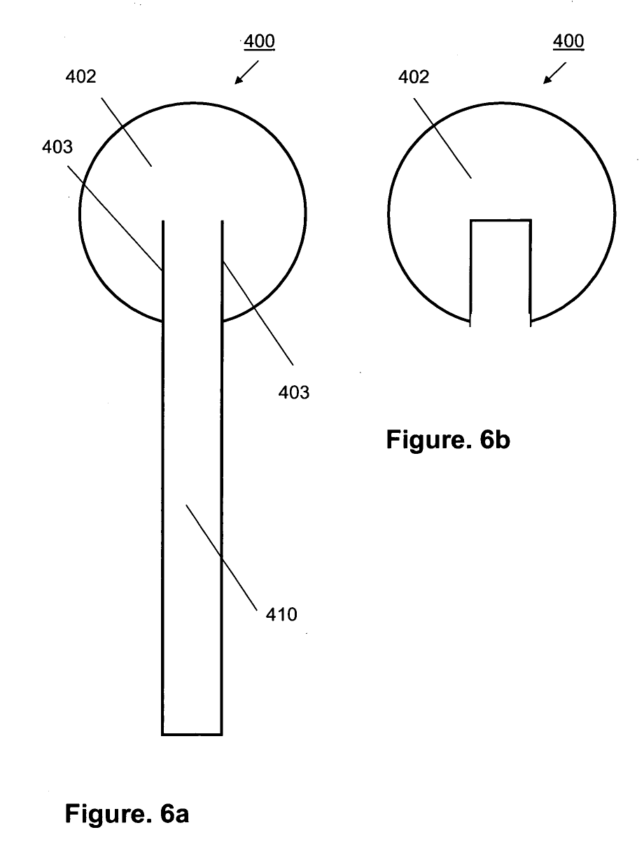

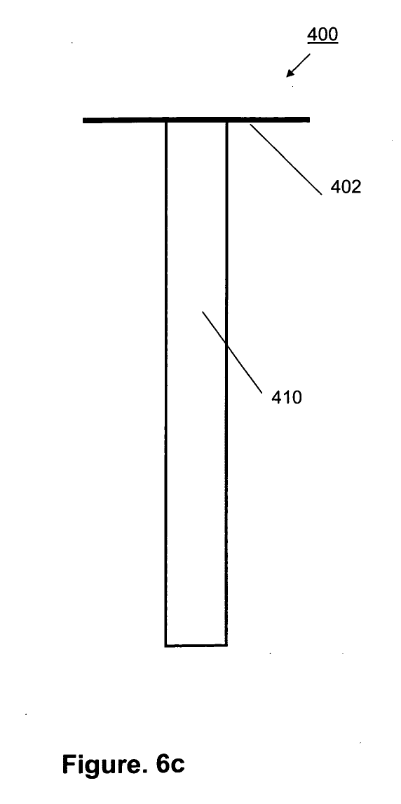

Referring to FIGS. 6a to 6c, a door shipping clip 400 according to another embodiment of the invention is provided. The door shipping clip 400 is made of a plate of suitable material such as, for example, steel or aluminum forming a door interacting portion 402 and a strike jamb interacting portion 410 in a single plane and comprising cuts 403, as illustrated in FIG. 6a. Prior mounting to a door assembly the strike jamb interacting portion 410 is bent substantially perpendicular to the door interacting portion 402, as illustrated in FIGS. 6b and 6c. The mounting process is then the same as described herein above. Optionally, apertures are provided in mounting section of the strike jamb interacting portion 410 for facilitating mounting of the strike jamb interacting portion 410.

The present invention has been described herein with regard to preferred embodiments. However, it will be obvious to persons skilled in the art that a number of variations and modifications can be made without departing from the scope of the invention as described herein.

What is claimed is:

1. A door shipping clip comprising:
a substantially rigid door interacting portion for interacting with a surface of the door in proximity of a door lock bore disposed in the door; and,
an elongated bendable strike jamb interacting portion extending from the door interacting portion for being disposed through the door lock bore and for interacting with a surface of the strike jamb, the strike jamb interacting portion in concert with the door interacting portion for holding the door in a closed position with a strike edge of the door abutting a respective abutting surface of the strike jamb.

2. A door shipping clip as defined in claim 1 comprising:
a guiding portion interposed between the door interacting portion and the strike jamb interacting portion for interacting with a surface of the door lock bore to position the door shipping clip with respect to the door lock bore.

3. A door shipping clip as defined in claim 1 wherein the door interacting portion comprises a cap covering the door lock bore.

4. A door shipping clip as defined in claim 1 wherein the strike jamb interacting portion is designed for being mounted to a wall facing surface of the strike jamb.

5. A door shipping clip as defined in claim 4 wherein the strike jamb interacting portion comprises a mounting structure for being mounted to a wall facing surface of the strike jamb.

6. A door shipping clip as defined in claim 1 wherein the strike jamb interacting portion is designed to interact with the surface of the strike jamb through plastic deformation.

7. A door shipping clip as defined in claim 1 wherein the door interacting portion and the strike jamb interacting portion are made as a single unit.

8. A door shipping clip as defined in claim 7 wherein the single unit is made of a molded plastic material.

9. A door shipping clip as defined in claim 1 wherein the strike jamb interacting portion comprises a removal mechanism for facilitating removal of the door shipping clip after installation.
